(19) United States
(12) Patent Application Publication
(10) Pub. No.: US 2017/0235379 A1
(43) Pub. Date: Aug. 17, 2017

(54) USER INTERFACE FOR A COMMUNICATION SYSTEM

(71) Applicant: CARDO SYSTEMS, INC., Pittsburgh, PA (US)

(72) Inventors: Abraham Glezerman, Tel Aviv (IL); Avraham Kushnirov, Ra'anana (IL); Abraham Moato, Rishon Le'Zion (IL)

(73) Assignee: CARDO SYSTEMS, INC., Pittsburgh, PA (US)

(21) Appl. No.: 15/502,557

(22) PCT Filed: Aug. 11, 2015
(86) PCT No.: PCT/IL2015/050817

§ 371 Date: Feb. 8, 2017

(30) Foreign Application Priority Data
Aug. 11, 2014 (IL) 234050

(51) Int. Cl. G06F 3/0338; A42B 3/30; B62J 99/00; G06F 3/0485; G06F 3/02

(52) U.S. Cl. CPC G06F 3/0338; G06F 3/0485; G06F 3/0219; B62J 99/00; A42B 3/303; B62J 2099/0006

(57) ABSTRACT

A user interface device for applying control signals to a communication system, comprising: at least one pressure-activated multidirectional tiltable/pushable plate with multiple pressureable areas, wherein each of said pressureable areas activates a corresponding pressure element that is located under said plate, wherein each activation of a specific pressure element defines an action which is respectively performed upon tilting-pressing of said plate towards the location of the respective pressure element.

### FIELD OF THE INVENTION

The present invention relates to communication systems. More particularly, the invention relates to a user interface for communication systems suitable for use in conjunction with a helmet such as, but not limited to, those worn by drivers and passengers of motorcycles.

### BACKGROUND OF THE INVENTION

Mobile communication systems suitable for use in conjunction with a helmet are known in the art such as, but not limited to, the Scala Rider line of products by Cardo systems, Inc. Such communication systems may vary from one product to another, and may include, for example, intercom that enable a motorcycle rider to connect via voice command to 8 additional riders within a range of up to 1 mile/1.6 km, intelligent voice recognition technology means, Bluetooth systems, whether autonomous or operating through a portable communication device, such as a smart phone, or systems employing different wireless communication systems and protocols.

So far, the art has failed to provide a user interface for communication system that provides safety and convenience of operation, in particular while wearing gloves. It is an object of the present invention to provide user interface device that is mounted on the side portion of a helmet, and yet can be easily and conveniently operated by the wearer.

It is another object of the invention to provide a user interface device comprising elements operable by simple movements of the hands or fingers, which can be used by the wearer to operate the communication system, even while wearing gloves.

Other objects and advantages of the invention will become apparent from the description to follow.

### SUMMARY THE INVENTION

In one aspect, the invention relates to a user interface device (UID) for applying control signals to a communication system, which comprises at least one pressure-activated element that is operated by a multidirectional tiltable/pushable plate with at least one pressureable area, wherein each of said pressureable areas defines an action and is activated by tilting/pressing said plate towards the desired pressurable area, such that each of said actions or combinations of them results in activating one or more tasks of said communication system.

In another aspect, the invention relates to a user interface device (UID) for applying control signals to a communication system, which comprises at least one scroll-activated element, wherein each scroll of said scroll-activated element, in any direction either forward or backward, defines an action, such that each of said actions or combinations of them results in activating one or more tasks of said communication system.

In yet another aspect, the invention relates to a user interface device (UID) for applying control signals to a communication system, which comprises both a tiltable/pushable plate with at least one pressure activated area, and the at least one scroll-activated element.

In order to communicate with autonomous communication means of the user (e.g., Bluetooth-enabled phone) or other external communication devices or remote equipment, the communications system that includes the UID of the invention includes also communication circuitry such as a Bluetooth module, and at least one antenna

According to an embodiment of the invention, the pressure-activated element and/or the scroll-activated element are embedded within a housing of the communication system.

According to an embodiment of the invention, the housing is adapted to be mounted on a helmet either directly or via a dedicated cradle.

According to an embodiment of the invention, the pressure-activated elements include discrete keys, such that the user interface device includes regular pressure keys in addition to the tiltable/pushable plate.

According to an embodiment of the invention, the scroll-activated element includes a clickable element that is activated by pressing on the scroll activated element, such that each click on said clickable element or set of following clicks define an action, wherein the scroll-activated element is configured in such a way that the press on the clickable element is perpendicular to the scroll-activated element axis.

According to an embodiment of the invention, the scrolling action of the scroll-activated element is limited in its rolling movement in one direction or in both directions forward or backward.

According to an embodiment of the invention, the scroll-activated element rolls in one direction only or does not roll at all, either not forward or backward.

According to an embodiment of the invention, the control signal applied to the communication system via a processing unit that converts the activation of the pressureable areas into control signals.

In another aspect, the present invention relates to a user interface device for applying control signals to a communication system, comprising: at least one scroll-activated element, wherein each scroll of said scroll-activated element, by swiping the user's hand/finger over it in a linear motion, either forward or backward, defines an action, such that each of said actions or combinations of them results in activating one or more tasks of the communication system.

According to an embodiment of the invention, the scroll-activated element include discrete keys, such that the user interface device includes regular pressure keys in addition to a roller or other scrollable element.

According to an embodiment of the invention, the rolling axis of the scroll activated element, is approximately perpendicular to the normal of a surface on which the communication system is situated, in particular on a helmet.

According to an embodiment of the present invention, the pressure-activated element and the scroll-activated element are adapted to be easily reached and operated by the fingers or hands of the wearer of the helmet, in particular while wearing gloves.

### BRIEF DESCRIPTION OF THE DRAWINGS

In the drawings:

FIG. 1 is a top view of an interface device having a roller and a touch plate, according to one embodiment of the invention;

FIG. 2 is a perspective view of the interface device according to one embodiment of the invention with detailed view of the roller degrees of freedom;

FIGS. 3 (A and B) are perspective views of the interface device according to some embodiments of the invention, with optional arrays of platform press locations;

FIG. 4 schematically illustrates a communication system, in accordance with another embodiment of the present invention; and

FIG. 5 schematically illustrates the communication system of FIG. 4 partially without the “top” shell of its main body.

### DETAILED DESCRIPTION OF THE INVENTION

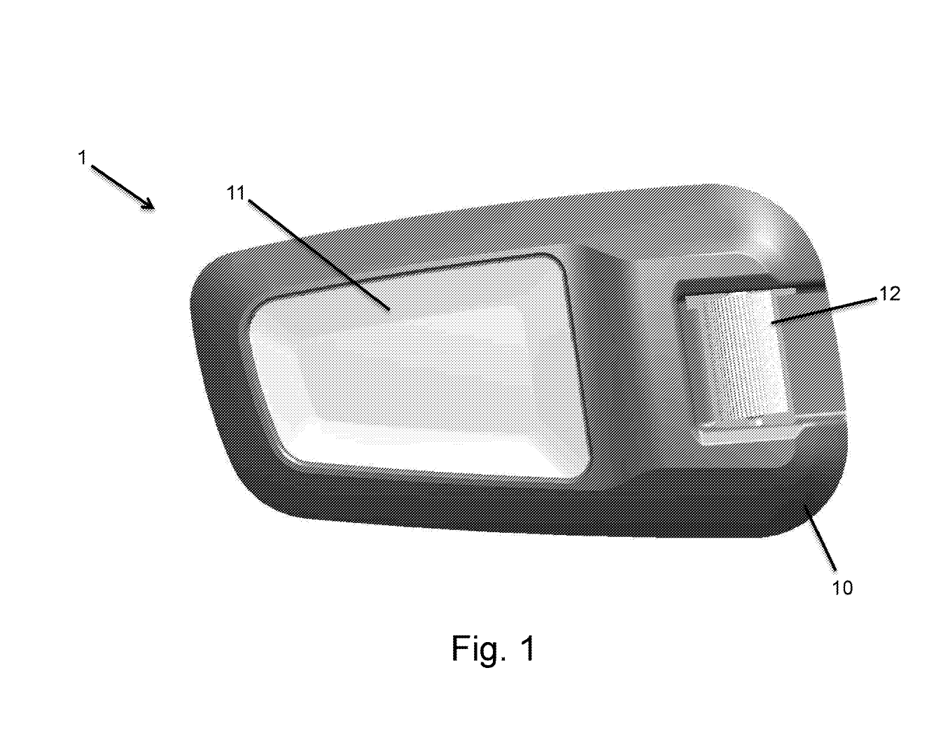

Looking now at FIG. 1, a novel user interface device (UID) for applying control signals to a communication system 1 is generally illustrated in accordance with an embodiment of the present invention. In this embodiment, the UID includes a pressure-activated element 11 having multiple pressureable or touch-operated areas, and a scroll-activated element 12 (which is known in the art as “roller”). Accordingly, the invention is illustrated in the appended drawings using a main body 10 of the communication system 1 that houses the elements 11 and 12 of the user interface device, without intending to limit the invention thereby. Both elements 11 and 12 afford easy access to the user's fingers.

As will be apparent to the skilled person and as further discussed hereinafter, the UID may include more than one variation or combination of the pressure-activated element 11 or scroll-activated element 12. For example, in this embodiment the pressure-activated element 11 and the scroll-activated element 12 are located on the same side of the main body 10. According to other embodiments of the invention, the pressure-activated element 11 can be located at one side of the housing 10, and the scroll-activated element 12 on another side or in other orientation.

According to an embodiment of the invention, the communication system 1 comprises a processing unit (not shown) adapted to convert signals received from the operation of the UID elements 11 and 12 into control signals for operating different functionalities of the communication system 1. The communication system 1 may further comprise a communication circuitry (not shown) adapted to transmit and receive the control signals to a communication system associated with it in a wired or wireless manner (e.g., Bluetooth). In one embodiment of the invention an antenna needed for wireless communication to take place is located inside the main body 10. The electric arrangements and connections between these UID elements, as well as the connection between the UID elements and the communication system 1, can be effected in a variety of ways, which would be readily apparent to the skilled person and, therefore, are not illustrated herein in detail, for the sake of brevity.

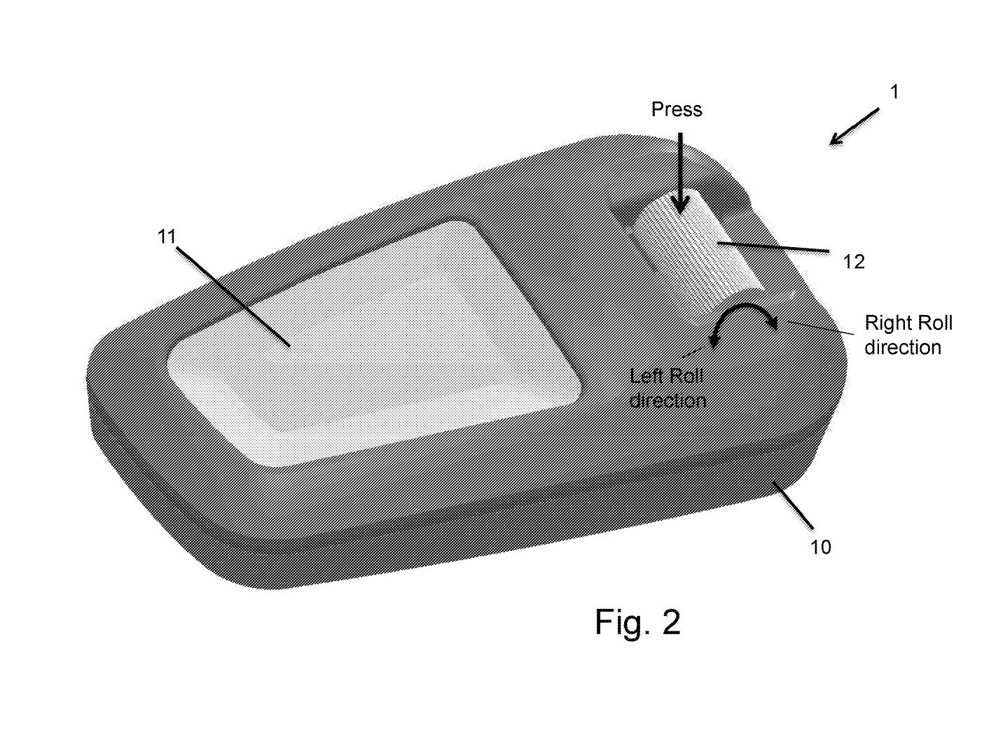

FIG. 2 schematically illustrates the degrees of freedom of the “roller” (i.e., the scroll-activated element 12 of the UID), according to an embodiment of the invention. The scroll-activated element 12 can be either pressed or scrolled backward/forward (e.g., rotation to the left and right directions), similar to the operation of a common wheel of a computer mouse, thereby providing three degrees of freedom. Each movement of the scroll-activated element 12, click on top of it or any combination thereof can define a different action by dedicated software or programming of the processing unit.

The communication system 1 provided with the novel UID of the present invention can be positioned at the side portion of the helmet (e.g., roughly corresponding to the middle of the wearer's cheek). However, the aforesaid is of particular importance for the roller/pressure elements that the wearer of the helmet must operate while riding, but this is not intended to limit the invention in any way.

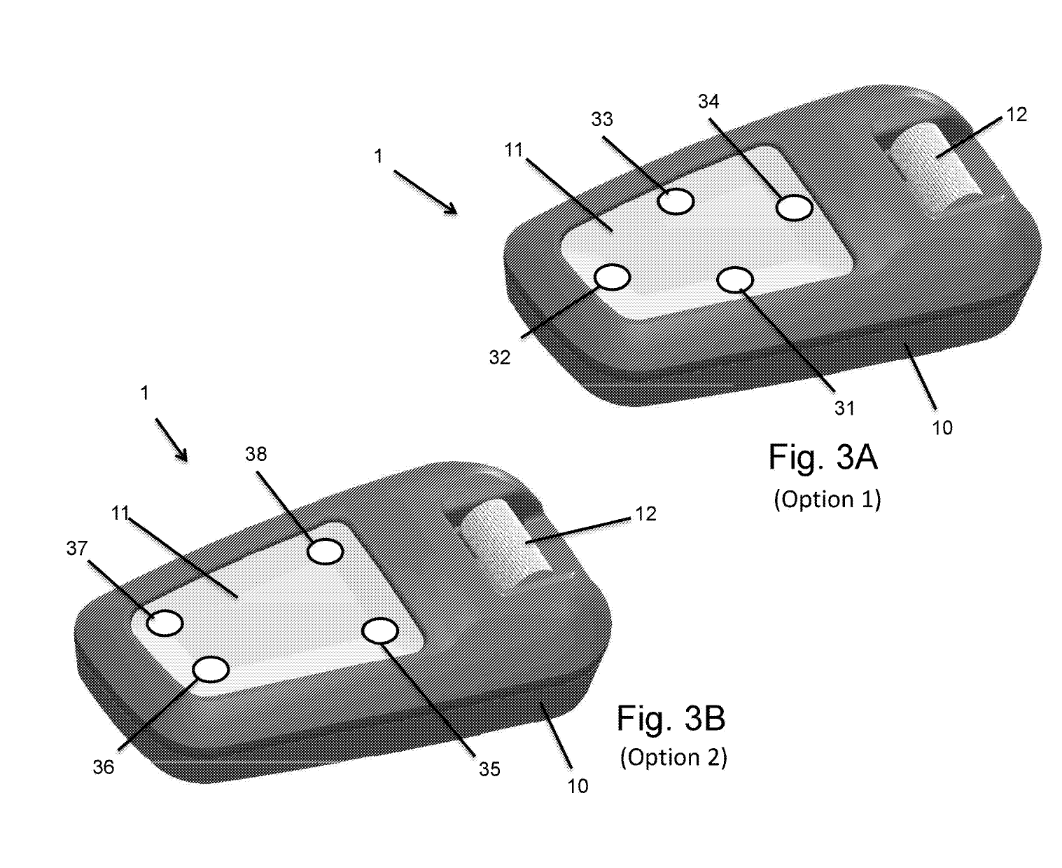

FIGS. 3A and 3B show the communication system 1 with different arrays of press locations on the pressure-operated element 11, according to some embodiment of the invention. The pressure-operated element 11 comprises multiple pressureable areas, each of which defines a different action “key”.

A first optional array is shown in the illustrative embodiment of the invention in FIG. 3A, and the action “keys” are indicated by numerals 31, 32, 33 and 34. A second optional array is shown in the illustrative embodiment of the invention in FIG. 3B, and the action “keys” are indicated by numerals 35, 36, 37 and 38. Each key may be assigned a different role, such as “on” and “off”, “speak”, etc. A wider variety of tasks for controlling the communication system 1 or a remote/paired communication system can be applied by combining the activation of the action “keys” of the element 11 and the degrees of freedom of element 12. The activation of an action “key” can also be obtained by applying relatively long presses (e.g., 2-5 seconds) or multiple consecutive presses on the same key/roller, depending on the programming of the processing unit. In the same manner, the roller can also be operated with consecutive or longer presses.

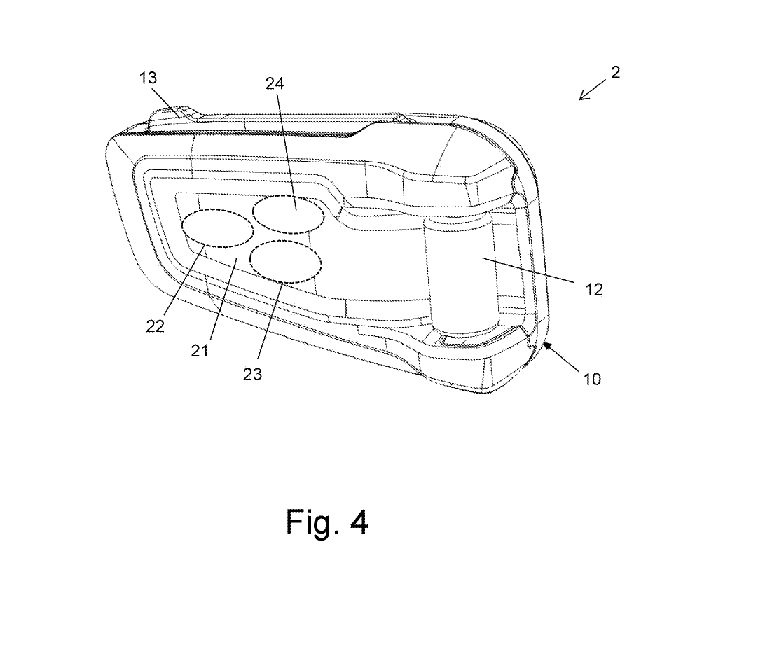

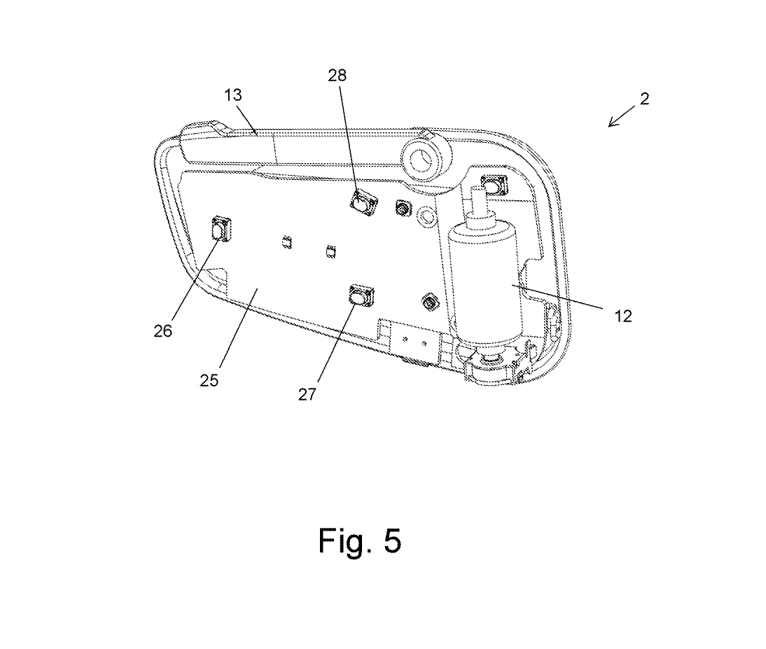

FIG. 4 schematically illustrates a communication system 2, in accordance with another embodiment of the present invention. FIG. 5 schematically illustrates the communication system 2 partially without the “top” shell of the main body 10. In this embodiment, the pressure-activated element includes a multidirectional tiltable/pressable plate 21 with three pressureable areas 22, 23 and 24 and three pressure elements 26, 27, 28 that are located under plate 21, respectively. Each of the pressure elements 26-28 can be activated by tilting/pressing the plate 21 towards the desired pressure element while pressing on the pressurable area above it. The processing and communications circuitries adapted for receiving the control signals are generally indicated by numeral 25 (e.g., in form of a Printed Circuit Board (PCB)). In this embodiment, the pressure elements 26, 27, 28 are tact switches located on the PCB 25. The dotted circles schematically illustrate the pressureable areas 22-24 on the outer surface of the multidirectional tiltable plate 21 upon which the rider may press to activate each of the pressure elements 26-28. As can be easily seen in the figures, the tiltable/pushable plate 21 allows the user to press on a larger area than the original size of the correspondence pressure element located under it, thereby allowing the user to easily operate the communication system 1, e.g., while riding a motorcycle and even when wearing gloves.

In this embodiment, the communication system 2 includes an external foldable RF antenna 13 that is located outside the main body 10, as best seen in FIG. 5. The communication system 2 may also include an internal antenna (e.g., Bluetooth antenna) that can be located inside the main body 10.

All the above description of illustrative embodiments of the invention have been provided for the purpose of illustration only and are not meant to limit the invention in any way. As will be apparent to the skilled person, many different shapes of the UID embedded/integrated within a communication system can be devised. Many variations of the illustrative embodiments can be provided without exceeding the scope of the invention as defined in the claims.

1. A user interface device for applying control signals to a communication system, comprising: at least one pressure-activated multidirectional tiltable/pushable plate with multiple pressureable areas, wherein each of said pressureable areas activates a corresponding pressure-activated element that is located under said plate, wherein each activation of a specific pressure-activated element defines an action which is respectively performed upon tilting-pressing of said plate towards the location of the respective pressure-activated element.

2. A user interface device according to claim 1, wherein at least one scroll-activated element, wherein each scroll of said at least one scroll-activated element, in any direction either forward or backward defines an action, such that each of said actions or combinations of said actions results in activating one or more tasks of the communication system.

3. A user interface device according to claim 2, in which each pressure-activated element and/or each scroll-activated element are embedded within a housing of the communication system.

4. A user interface device according to claim 3, in which the housing is adapted to be mounted on a helmet either directly or via a dedicated cradle.

5. A user interface device according to claim 2, in which each pressure-activated element and each scroll-activated element are designed to be easily reached and operated by the fingers or hands of a wearer of a helmet.

6. A user interface device according to claim 1, in which the pressure-activated elements include discrete keys, such that the user interface device includes regular pressure keys in addition to the tiltable/pushable plate.

7. A user interface device according to claim 2, in which the at least one scroll-activated element includes a clickable element that is activated by pressing on the at least one scroll activated element in a direction perpendicular to the scroll-activated element axis, such that each click on said clickable element or set of following clicks define an action.

8. A user interface device according to claim 7, in which the scroll-activated element rolls in one direction or does not roll at all either forward or backward.

9. A user interface device according to claim 1, in which the control signal applied to the communication system via a processing unit that converts the activation of the pressureable areas into control signals.

10. A user interface device according to claim 1, in which the communication system comprising at least one communication circuitry and antenna for communicating with an external communication device.

11. A user interface device for applying control signals to a communication system, comprising: at least one scroll-activated element, wherein each scroll of said scroll-activated element, by swiping the user's hand/finger over it in a linear motion, either forward or backward, defines an action, such that each of said actions or combinations of said actions results in activating one or more tasks of the communication system.

12. A user interface device according to claim 11, in which a rolling axis of the at least one scroll activated element, is approximately perpendicular to the normal of a surface on which the communication system is situated.

13. A user interface device according to claim 11, in which the at least one scroll-activated element is embedded within a housing of the communication system.

14. A user interface device according to claim 13, in which the housing is adapted to be mounted on a helmet either directly or via a dedicated cradle.

15. A user interface device according to claim 11, in which the at least one scroll-activated element include discrete keys, such that the user interface device includes regular pressure keys in addition to a roller or other scrollable element.

16. A user interface device according to claim 11, in which the at least one scroll-activated element includes a clickable element that is activated by pressing on the scroll activated element, such that each click on said clickable element or set of following clicks define an action, wherein the is the at least one scroll-activated element is configured to be pressed perpendicular to a rolling axis of the scroll-activated element.

17. A user interface device according to claim 11, in which scrolling action of the at least one scroll-activated element is limited in its rolling movement in one direction or in both directions forward or backward, and the at least one scroll-activated element also has a state of not to rolling at all.

18. A user interface device according to claim 11, in which the control signal applied to the communication system via a processing unit that converts the scrolls of the at least one scroll-activated element into control signals.

19. A device according to claim 11, in which the communication system comprising at least one communication circuitry and antenna for communicating with an external communication device.
